(19) United States
(12) Patent Application Publication
(10) Pub. No.: US 2024/0326286 A1
(43) Pub. Date: Oct. 3, 2024

(54) CONCRETE ELEMENT AND METHOD FOR THE PRODUCTION OF SAME

(71) Applicant: Metten Technologies GmbH & Co. KG, Overath (DE)

(72) Inventors: Guido Volmer, Erwitte (DE); Michael Metten, Bergisch Gladbach (DE)

(21) Appl. No.: 18/575,565

(22) PCT Filed: Jun. 30, 2022
(86) PCT No.: PCT/EP2022/068093

§ 371 Date: Jun. 14, 2024

(30) Foreign Application Priority Data
Jun. 30, 2021 (DE) 10 2021 116 928.3

(51) Int. Cl. B28B 1/00; B28B 11/08; B28B 13/02; C04B 28/00; C04B 28/02

(52) U.S. Cl. CPC B28B 1/008; B28B 11/0818; B28B 13/022; C04B 28/008; C04B 28/02

(57) ABSTRACT

The invention relates to a concrete element comprising a core concrete layer and a face concrete layer, wherein the concrete element is obtained by compressing and curing a core concrete layer mixture in contact with a face concrete layer mixture, wherein the core concrete layer mixture contains a latent hydraulic core binder and/or a pozzolanic core binder, water, a granular core material and an alkaline core curing agent, wherein the face concrete layer mixture contains a latent hydraulic face binder and/or a pozzolanic face binder, water, a granular face material and an alkaline face curing agent, and wherein the concrete element has a compressive strength in accordance with DIN EN 12390-3, in particular DIN EN 12390-3:2019-10, measured after 28 days, of less than 120 N/mm². The invention also relates to a method for producing the concrete element.

The invention relates to a concrete element comprising a core concrete layer and a face concrete layer, wherein the concrete element is obtained by compressing and curing a core concrete layer mixture in contact with a face concrete layer mixture, wherein the core concrete layer mixture and the face concrete layer mixture each contain a latent hydraulic binder and/or a pozzolanic binder, water, a granular core material and an alkaline curing agent. The invention also relates to a method for producing the concrete element according to the invention.

Concrete elements, such as concrete blocks, concrete slabs, concrete wall elements or concrete steps, are often preferred over stones, plates or steps made of natural stone due to their durability and lower price. Concrete elements are usually produced by using cement as a binder.

Various methods have been developed to enable the concrete elements to look decorative. For this purpose, pigment and/or natural stone aggregates and/or sands, among other things, are usually added to provide color to, and refine, the concrete element.

Cement-containing concrete elements sometimes have the problem that they develop whitish spots, so-called efflorescence, on the surface over time. The color of colored concrete blocks may also fade. Both effects appear to be caused by the formation of lime. The whitish spots on the surface are attributed to lime efflorescence, which is formed by the reaction of calcium hydroxide transported to the surface with carbon dioxide. It is believed that the color fading is caused, among other things, by the fact that the pigment that has settled on the cement particles to provide color is slowly coated with calcium carbonate that develops. This is how the color impression of the pigment is slowly lost.

Binders that are an alternative to cement are known. An example of such alternative binders is based on the chemical building blocks SiO₂ in combination with Al₂O₃. Examples of such binders are latent hydraulic binders and pozzolanic binders. These are often referred to as “geopolymers.” EP 1 236 702 A1 describes for example a building material mixture containing sodium silicate and a latent hydraulic binder. EP 1 236 702 A1 proposes to use the building material mixture as a mortar or filler.

The production of concrete elements, such as concrete blocks, concrete slabs, concrete wall elements or concrete steps, places special demands on the concrete mix used, especially when compared to fresh concrete. When producing concrete elements, it is desirable to achieve the highest possible stability of the not yet cured concrete blocks after as short a time as possible so that they can be packed as quickly as possible. An additional requirement for the products that comprise a face concrete layer and core concrete layer is a high bond strength in order to prevent the face concrete layer from delaminating from the core under load and weathering. The bond adhesive tensile strength can be used to measure the resistance of the face concrete layer against a delamination from the core concrete of the concrete elements. If the bond adhesive tensile strength of the concrete elements is not high enough, the face concrete layer and core concrete can separate under load (delamination) or tear apart when the formwork is removed. The concrete elements can thus be used for a wider range of applications if they are designed with sufficiently high bond adhesive tensile strength.

WO 2021/047875 A1 describes concrete elements comprising a core concrete layer and a face concrete layer, wherein the face concrete layer contains a latent hydraulic binder and/or a pozzolanic binder. However, WO 2021/047875 A1 does not specify that latent hydraulic binders and/or pozzolanic binders are also used in the core concrete layer.

Concrete elements are exposed to various attacks over their service life which cause the concrete elements to corrode. In addition to physical corrosion, for example due to frost and de-icing salt, chemical corrosion, including the alkali-silica reaction as a triggering attack, is also a significant form of corrosion. The alkali-silica reaction occurs in particular with alkali-rich binders in combination with alkali-sensitive aggregates, such as graywacke. These alkali-sensitive aggregates are rarely found in a face concrete layer for which higher quality aggregates are usually used, but are mostly used for the core concrete layer. Therefore, there have been no efforts to date to use alkali-rich binders, such as geopolymers in the core concrete layer, as this would have led to problems with the alkali-silica reaction due to the alkali-sensitive aggregates. In addition, the latent hydraulic binders and pozzolanic binders in combination with the curing agents required for this are more expensive than cementitious binders. For this reason, a conventional, i.e., cementitious core concrete layer is usually used as the core concrete layer.

In the course of the development of the present invention, it was found that concrete elements with a cementitious core concrete layer and a face concrete layer, which contains latent hydraulic binders and/or pozzolanic binders, have a lower bond adhesive tensile strength under otherwise comparable production conditions and components than concrete elements in which both layers are cementitious.

An object of the invention was thus to provide aesthetically pleasing concrete elements which change their appearance less over time, are less susceptible to chemical corrosion, in particular the alkali-silica reaction, and can be produced economically. In particular, concrete blocks are to be provided which show less staining and/or a tendency to become dirty on the surface and/or less color fading and/or have a sufficiently high adhesive tensile strength, in particular a sufficiently high bond adhesive tensile strength. Another object of the invention is to provide concrete elements with a reduced CO₂ footprint.

Further objects, some of which are listed below, result from the following embodiments.

The invention achieves all or some of these objects with the concrete element according to claim 1 and the method according to claim 22.

Advantageous embodiments of the invention are specified in the dependent claims and are explained in detail below.

The invention provides a concrete element comprising a core concrete layer and a face concrete layer, wherein the concrete element is obtained by compressing and curing a core concrete layer mixture in contact with a face concrete layer mixture,
wherein the core concrete layer mixture contains a latent hydraulic core binder and/or a pozzolanic core binder, water, a granular core material and an alkaline core curing agent,
wherein the face concrete layer mixture contains a latent hydraulic face binder and/or a pozzolanic face binder, water, a granular face material and an alkaline face curing agent, wherein the granular face material has, at a screen hole width of 2 mm, a through fraction from 35.5 wt. % to 99.5 wt. %, and, at a screen hole width of 0.25 mm, a through fraction from 2.5 wt. % to 33.5 wt. %, in each case based on the total weight of the granular face material, and wherein the concrete element has a compressive strength in accordance with DIN EN 12390-3, in particular DIN EN 12390-3:2019-10, measured after 28 days, of less than 120 N/mm².

Surprisingly, it has been found that concrete elements comprising a core concrete layer and a face concrete layer, wherein the concrete element is obtained by compressing and curing a core concrete layer mixture in contact with a face concrete layer mixture, wherein the core concrete layer mixture contains a latent hydraulic core binder and/or a pozzolanic core binder, water, a granular core material and an alkaline core curing agent, wherein the face concrete layer mixture contains a latent hydraulic face binder and/or a pozzolanic face binder, water, a granular face material and an alkaline face curing agent, wherein the granular face material has, at a screen hole width of 2 mm, a through fraction from 35.5 wt. % to 99.5 wt. %, and, at a screen hole width of 0.25 mm, a through fraction from 2.5 wt. % to 33.5 wt. %, in each case based on the total weight of the granular face material, change their decorative properties only slowly, if at all, and can be produced economically. The aforementioned concrete elements have, in particular, a sufficiently high bond adhesive tensile strength. This allows a wide range of applications for the concrete elements. Furthermore, these concrete blocks show at most a slow fading of the colors and little or no staining on the surface. Furthermore, the concrete blocks according to the invention exhibit good resistance to the alkali-silica reaction. Finally, these concrete elements also have a good CO₂ footprint.

Without wishing to be bound by any particular scientific theory, this appears to be due to the fact that the use of latent hydraulic binder and/or pozzolanic binder in the core concrete layer and in the face concrete layer increases the bond adhesive tensile strength between the core concrete layer and the face concrete layer, but does not significantly increase the susceptibility to chemical corrosion of the core concrete layer in particular. Apparently, the use of latent hydraulic binder and/or pozzolanic binder in both the face concrete layer and the core concrete layer improves the bond adhesive tensile strength between these two layers. Furthermore, the concrete elements appear to lose their decorative properties only slowly or not at all as a result of the use of latent hydraulic binders and/or pozzolanic binders. This seems to be caused by the fact that the concrete elements according to the invention contain less CaO than the concrete elements which usually contain a lot of cement. It has also been found that by using a granular material which, at a screen hole width of 2 mm, has a through fraction from 35.5 wt. % to 99.5 wt. % and, at a screen hole width of 0.25 mm, has a through fraction from 2.5 wt. % to 33.5 wt. %, good adhesive tensile strengths in the face concrete layer itself can be achieved when latent hydraulic binders and/or pozzolanic binders are used. It was possible to produce concrete elements with granular material having larger diameters, but their adhesive tensile strength in the face concrete layer was not as good. Without wishing to be bound by any scientific theory, the improved adhesive tensile strength could be due to the fact that the components of the granular material with rather smaller diameters have a smaller mean distance from one another. This means that shorter chains of latent hydraulic binder and/or pozzolanic binder can link the components of the granular material to one another, thereby improving the mechanical properties and in particular the adhesive tensile strength of concrete elements that have not yet cured.

The core concrete layer mixture can also be referred to as the core concrete mixture. The face concrete layer mixture can also be referred to as the face concrete mixture.

The core concrete layer can also be referred to as the core layer. The face concrete layer can also be referred to as the face layer.

The granular material can also be referred to as aggregate.

The not yet cured concrete elements can also be referred to as green concrete elements.

The bond adhesive tensile strength can be determined on concrete blocks with a certain testing age, for example 28 days. Concrete elements according to the invention preferably have a bond adhesive tensile strength of 1 MPa and more after 28 days. The bond adhesive tensile strength can in particular be measured according to the DAfStb (German Committee for Reinforced Concrete) directive “Protection and repair of concrete components”, Part 4, Section 5.5.11, 2001.

Preferably, the granular face material has, at a screen hole width of 2 mm, a through fraction of 42.5 wt. % to 99.5 wt. %, more preferably from 56.5 wt. % to 98.5 wt. %, particularly preferably from 72.5 wt. % to 97.5 wt. %, and, at a screen hole width of 0.25 mm, a through fraction of 2.5 wt. % to 27.5 wt. %, more preferably from 2.5 wt. % to 22.5 wt. %, even more preferably from 2.5 wt. % to 21.5 wt. %, particularly preferably from 2.5 wt. % to 8 wt. % or from 11.5 wt. % to 21.5 wt. %, and, at a screen hole width of 0.125 mm, a through fraction of 0.1 wt. % to 12.5 wt. %, more preferably from 0.3 wt. % to 10.0 wt. %, even more preferably from 0.3 wt. % to 7.5 wt. %, particularly preferably from 0.3 wt. % to 5.0 wt. %, based on the total weight of the granular face material. It has been found that granular face material with the above-mentioned through fractions at the aforementioned screen hole widths can result in concrete elements with good adhesive tensile strength in the face layer.

Expediently, the granular core material has, at a screen hole width of 8 mm, a through fraction from 42.5 wt. % to 99.5 wt. %, preferably from 56.5 wt. % to 98.5 wt. %, more preferably from 72.5 wt. % to 97.5 wt. %, and, at a screen hole width of 0.5 mm, a through fraction from 7.5 wt. % to 39.5 wt. %, preferably from 13.5 wt. % to 37.5 wt. %, particularly preferably from 25.5 wt. % to 37 wt. %, or from 14.5% to 24.5 wt. %, based on the total weight of the granular core material.

According to one embodiment, with respect to the particle size distribution, the granular core material exhibits a distribution that is finer of grading curve A16 and coarser of grading curve C16, preferably finer of grading curve B16 and coarser of grading curve C16. According to another embodiment, with respect to the particle size distribution, the granular core material exhibits a distribution that is finer of grading curve A8 and coarser of grading curve C8, preferably finer of grading curve A8 and coarser of grading curve B8. The aforementioned grading curves meet the specifications of DIN 1045.

It has been found that granular core material with the above-mentioned through fractions at the aforementioned screen hole widths can result in concrete elements with good adhesive tensile strength in the core concrete layer.

The above-mentioned through fractions for the two screen hole widths of the granular face material can be combined with one another as desired. The above-mentioned through fractions for the two screen hole widths of the granular core material can be combined with one another as desired.

The granular face material can also have a grain size number from 1.59 to 3.62, preferably from 1.61 to 3.17, particularly preferably from 1.61 to 2.55. The granular core material can also have a grain size number from 1.97 to 4.61, preferably 2.27 to 3.82. The grain size number is a characteristic value for the grain composition of an aggregate, determined as the sum of the residues on the screens of the standardized test screen set in %, divided by 100. The grain composition is determined in accordance with DIN EN 12620:2008-07, para. 4.3. The test screen set is the screen set in accordance with DIN EN 933-2:2020-09 and the screens meet the requirements of DIN ISO 3310-1:2017-11.

The granular face material preferably has a graded grain composition. The granular core material preferably has a graded grain composition. A graded grain composition comprises components with different grain sizes.

The granular face material can be contained in the face mixture in different amounts. The face mixture advantageously contains 55 wt. % to 80 wt. %, preferably 60 wt. % to 75 wt. %, more preferably 60 wt. % to 72 wt. %, of the granular face material based on the total weight of the face mixture. The face mixture can particularly preferably contain 60 wt. % to 65 wt. %, in particular 60 to 64 wt. %, of the granular face material, based on the total weight of the face mixture. The face mixture can particularly preferably also contain 67 wt. % to 72 wt. % of the granular face material, based on the total weight of the face mixture.

The granular core material can be contained in the core mixture in different amounts. The core mixture advantageously contains 60 wt. % to 95 wt. %, preferably 65 wt. % to 92.5 wt. %, more preferably 70 wt. % to 90 wt. %, particularly preferably 74 wt. % to 79 wt. % of the granular core material, based on the total weight of the core mixture.

In addition to the components mentioned above, the face mixture can also contain other components, for example a face filler. The face mixture preferably contains 1 wt. % to 30 wt. %, preferably 1 wt. % to 20 wt. %, more preferably 5 wt. % to 18 wt. %, still more preferably 5 wt. % to 15 wt. %, even more preferably 5 wt. % to 10 wt. %, particularly preferably 6 wt. % to 8 wt. % of a face filler, based on the total weight of the face mixture.

The face filler preferably has, at a screen hole width of 0.025 mm, a through fraction from 63 wt. % to 99 wt. %, preferably from 68 wt. % to 99 wt. %, more preferably from 90 wt. % to 99 wt. % and particularly preferably from 95 wt. % to 99 wt. %, and, at a screen hole width of 0.015 mm, a through fraction from 38 wt. % to 73 wt. %, preferably from 58 wt. % to 67 wt. %, particularly preferably from 61 wt. % to 66 wt. %, based on the total weight of the face filler.

In addition to the components mentioned above, the core mixture can

also contain other components, for example a core filler. The core mixture advantageously contains 1 wt. % to 40 wt. %, preferably 10 wt. % to 30 wt. %, more preferably 12.5 wt. % to 30 wt. %, particularly preferably 15 wt. % to 27.5 wt. % of a core filler, based on the total weight of the core mixture.

The core filler preferably has, at a screen hole width of 0.025 mm, a through fraction from 63 wt. % to 99 wt. %, preferably from 68 wt. % to 99 wt. %, more preferably from 90 wt. % to 99 wt. % and particularly preferably from 95 wt. % to 99 wt. %, and, at a screen hole width of 0.015 mm, a through fraction from 38 wt. % to 73 wt. %, preferably from 58 wt. % to 67 wt. %, particularly preferably from 61 wt. % to 66 wt. %, based on the total weight of the core filler.

The above-mentioned through fractions for the two screen hole widths of the granular face material can be combined with one another as desired. The above-mentioned through fractions for the two screen hole widths of the core filler can be combined with one another as desired.

It has been found that, by using face and/or core fillers with the through fractions listed above at the screen hole widths mentioned, the adhesive tensile strengths in the face concrete layer and/or in the core concrete layer, in particular of concrete elements that have not yet cured, can be improved even further.

In particular, the combined use of a granular face and/or core material and a face and/or core filler with the above-mentioned respective through fractions at the mentioned screen hole widths achieves optimum results with respect to the adhesive tensile strength in the face concrete layer and/or in the core concrete layer. Furthermore, this also allows the face mixture to be adjusted in such a way that the decorative properties of the concrete element change very little or not at all.

Different materials can be used as face fillers. The face filler is preferably selected from the group consisting of rock powder, preferably classified rock powder, limestone powder, preferably classified limestone powder and mixtures thereof.

The statements made above for the face filler apply accordingly to the core filler.

Using the fillers mentioned above, it is possible to economically produce decorative concrete elements which have a wide range of uses and whose decorative properties do not fade or only fade slowly.

Latent hydraulic face binders and/or pozzolanic face binders can be contained in the face mixture in different amounts. Preferably, the face mixture contains 15 wt. % to 40 wt. %, preferably 20 wt. % to 30 wt. %, more preferably 20 wt. % to 24 wt. % or 26 wt. % to 29 wt. %, particularly preferably 22 wt. % to 24 wt. %, of latent hydraulic face binder and/or pozzolanic face binder, based on the total weight of the face mixture.

Accordingly, the face mixture can also contain only 15 wt. % to 40 wt. %, preferably 20 wt. % to 30 wt. %, further preferably 20 wt. % to 24 wt. % or 26 wt. % to 29 wt. %, more preferably 22 wt. % to 24 wt. %, of latent hydraulic face binder and no pozzolanic face binder, based on the total weight of the face mixture. The face mixture can also contain only 15 wt. % to 40 wt. %, preferably 20 wt. % to 30 wt. %, more preferably 20 wt. % to 24 wt. % or 26 wt. % to 29 wt. %, particularly preferably 22 wt. % to 24 wt. %, of pozzolanic face binder and no latent hydraulic face binder, based on the total weight of the face mixture.

Latent hydraulic core binders and/or pozzolanic core binders can be contained in the core mixture in different amounts. Preferably, the core mixture contains 10 wt. % to 50 wt. %, preferably 10 wt. % to 40 wt. %, of latent hydraulic core binder and/or pozzolanic core binder, based on the total weight of the core mixture.

Accordingly, the core mixture may also contain only 10 wt. % to 50 wt. %, preferably 10 wt. % to 40 wt. %, based on the total weight of the core mixture, of latent hydraulic core binder and no pozzolanic core binder. The core mixture may also contain only 10 wt. % to 50 wt. %, preferably 10 wt. % to 40 wt. %, based on the total weight of the core mixture, of pozzolanic core binder and no latent hydraulic core binder.

It has been found that the resulting concrete elements do not have sufficient strength in the face or core concrete layer when using less than 10 wt. % of a latent hydraulic binder and/or pozzolanic binder. In contrast, the use of more than 50 wt. % of a latent hydraulic binder and/or pozzolanic binder is uneconomical.

Different materials can be used as latent hydraulic face binders. The molar ratio of (CaO+MgO):SiO₂ in the latent hydraulic face binder is preferably from 0.8 to 2.5, more preferably from 1.0 to 2.0. Latent hydraulic face binders with a molar ratio of (CaO+MgO):SiO₂ in the aforementioned range cure well.

The latent hydraulic face binder is advantageously selected from the group consisting of slag, blast furnace slag, preferably blast furnace sand, in particular ground blast furnace sand, electrothermal phosphorus slag, steel slag and mixtures thereof. The latent hydraulic face binder is more preferably slag sand, in particular ground slag sand.

Slag can either be industrial slag, i.e., waste products from industrial processes, or synthetically produced slag. The latter is preferred because industrial slag is not always available in constant quantities and grades. Blast furnace slag, especially slag sand, is an example of slag.

Ground slag sand varies in terms of fineness and particle size

distribution depending on its origin and the type of treatment. The fineness has an influence on the reactivity. The Blaine value in particular can be used as a measure of the fineness. The ground slag sand preferably has a Blaine value of 200 to 1000 m² kg⁻¹, more preferably 450 to 650 m² kg⁻¹.

Electrothermal phosphorus slag is a waste product from the electrothermal phosphorus production. Electrothermal phosphorus slag is less reactive than blast furnace slag and contains approximately 45 to 50 wt. % CaO, approximately 0.5 to 3 wt. % MgO, approximately 38 to 43 wt. % SiO₂, approximately 2 to 5 wt. % Al₂O₃ and approximately 0.2 to 3 wt. % Fe₂O₃ as well as fluorides and phosphates.

Steel slag is a waste product from steel production and can vary considerably in its composition.

The molar ratio of (CaO+MgO):SiO₂ in the latent hydraulic binder is particularly preferably from 0.8 to 2.5 and the latent hydraulic binder is selected from the abovementioned materials.

The statements made above for the latent hydraulic face binder apply accordingly to the latent hydraulic core binder.

Different materials can be used as pozzolanic face binders. The pozzolanic face binder is preferably selected from the group consisting of amorphous silicon dioxide, precipitated silicon dioxide, pyrogenic silicon dioxide, microsilica, glass powder, fly ash, such as lignite fly ash or hard coal fly ash, metakaolin, natural puzzolans, such as tuff, trass or volcanic ash, natural and synthetic zeolites and mixtures thereof. In particular, the pozzolanic face binder is preferably amorphous silicon dioxide.

The amorphous silicon dioxide preferably shows no crystallinity in a powder diffractogram. Glass powder is preferably also considered amorphous silicon dioxide. The amorphous silicon dioxide advantageously has a SiO₂ content of at least 80 wt. %, preferably at least 90 wt. %. Preferably, precipitated silicon dioxide is obtained industrially by precipitating sodium silicate. Depending on the type of production, precipitated silicon dioxide can also be referred to as silica gel. Pyrogenic silicon dioxide is produced by reacting chlorosilanes such as silicon tetrachloride in an oxyhydrogen flame. Pyrogenic silicon dioxide is amorphous SiO₂ powder with a particle diameter of 5 to 50 nm and a specific surface area of 50 to 600 m² g⁻¹.

Microsilica is a byproduct of the silicon or ferrosilicon production and contains large amounts of amorphous SiO₂ powder. The particles have a diameter of approximately 0.1 um. The specific surface ranges from 15 to 30 m² g⁻¹.

Fly ash is formed during combustion in coal-fired power plants, for example. According to WO 2008/012438 A2, fly ash of the F class contains less than 8 wt. %, preferably less than 5 wt. % of CaO.

Metakaolin is formed by dehydrating kaolin. While kaolin releases physically bound water in temperatures ranging from 100 to 200° C., the breakdown of the lattice structure and the formation of metakaolin (Al₂Si₂O₇) takes place during temperatures ranging from 500 to 800° C. Pure metakaolin preferably contains approximately 54 wt. % of SiO₂ and approximately 46 wt. % of Al₂O₃.

The statements made above for the pozzolanic face binder apply accordingly to the pozzolanic core binder.

It has been found that the above-mentioned latent hydraulic and pozzolanic face binders and core binders can be used to produce concrete elements whose decorative properties do not fade or fade only very slowly and which have good bond adhesive tensile strength combined with a good CO₂ footprint.

Different materials can be used as an alkaline face curing agent. The alkaline face curing agent is preferably selected from the group consisting of alkali metal oxides, alkali metal hydroxides, alkali metal carbonates, alkali metal silicates, alkali metal aluminates and mixtures thereof, preferably consisting of alkali metal hydroxides, alkali metal silicates and mixtures thereof.

Examples of alkali metal oxides are Li₂O, Na₂O, K₂O, (NH₄)₂O and mixtures thereof. Examples of alkali metal hydroxides are LiOH, NaOH, KOH, NH₄OH and mixtures thereof. Examples of alkali metal carbonates are Li₂CO₃, Na₂CO₃, K₂CO₃, (NH₄)₂CO₃ and mixtures thereof. Because of its similarity to the alkali metal ions, ammonium ion is listed as well.

Alkali metal silicates are expediently selected from compounds with the empirical formula m SiO₂.n M₂O, where M is Li, Na, K or NH4 or a mixture thereof, preferably Na or K. The molar ratio of min ranges from 0.5 to 3.6, preferably from 0.6 to 3.0, particularly preferably from 0.7 to 2.0. Sodium silicate, in particular liquid sodium silicate, furthermore preferably liquid sodium and/or potassium silicate, has proven to be a particularly useful alkali metal silicate. Silica, in particular aqueous silica, is another useful alkali metal silicate.

The aforementioned alkaline face curing agents are preferably used as an aqueous solution. This makes metering easier.

The curing of the face concrete layer can be easily adjusted with the aforementioned alkaline face curing agents. Furthermore, these alkaline face curing agents show a good compatibility with the other components in the face mixture.

The alkaline face curing agent can be contained in the mixture in different amounts. Preferably, the face mixture contains 1 wt. % to 15 wt. %, preferably 1 wt. % to 10 wt. %, more preferably 3 wt. % to 5 wt. %, even more preferably 3.15 wt. % to 4.85 wt. %, even more preferably 3.25 wt. % to 3.65 wt. % or 4.0 wt. % to 4.75 wt. %, particularly preferably 4.25 wt. % to 4.75 wt. %, very particularly preferably 4.25 wt. % to 4.45 wt. %, of the alkaline face curing agent, based on the total weight of the face mixture. Good results are also obtained if the face mixture contains 3.25 wt. % to 3.65 wt. % of the alkaline face curing agent, based on the total weight of the face mixture. It was found that the face concrete layer cured too slowly when less than 1 wt. % of the alkaline curing agent was used. If more than 15 wt. % of alkaline curing agent is used, the curing can start too quickly, so that the resulting face concrete layer can no longer be compacted properly.

Different substances can be used as an alkaline core curing agent. The alkaline core curing agent preferably comprises at least one organic and/or at least one inorganic base.

Examples of inorganic bases are the above-mentioned alkaline face curing agents. Examples of organic bases are, in particular, amine bases such as ammonia and mono-, di- and trialkylamines, for example triethylamine.

The curing of the core concrete layer can be easily adjusted with the aforementioned alkaline core curing agents.

The alkaline core curing agent can be contained in the mixture in different amounts. The core mixture preferably contains 0.1 wt. % to 15 wt. %, preferably 0.5 wt. % to 10 wt. %, of the alkaline core curing agent, based on the total weight of the core mixture.

According to the invention, the face mixture contains water. Preferably, the face mixture contains 1 wt. % to 20 wt. %, preferably 3 wt. % to 15 wt. %, more preferably 3 wt. % to 7 wt. %, even more preferably 3.5 wt. % to 6.5 wt. %, even more preferably 4.0 wt. % to 6.2 wt. %, even more preferably 4.2 wt. % to 4.9 wt. %, very particularly preferably 4.2 wt. % to 4.8 wt. %, of water, based on the total weight of the face mixture. Good results are also obtained if the face mixture contains 5.2 wt. % to 6.2 wt. % of water, based on the total weight of the face mixture.

The core mixture preferably contains 1 wt. % to 20 wt. %, preferably 3 wt. % to 15 wt. %, more preferably 3 wt. % to 10 wt. %, of water, based on the total weight of the core mixture.

In addition to the components described above, the face mixture can also contain further components. The face mixture may, for example, also contain one or more aggregates, such as gravel, grit, sand, pearlite, kieselguhr or vermiculite. Furthermore, the face mixture can contain cement and/or one or more aggregates, such as gravel, grit, sand, perlite, kieselguhr or vermiculite, and/or one or more additives selected from the group consisting of plasticizers, anti-foaming agents, water retention agents, dispersants, pigments, fibers, redispersible powders, wetting agents, impregnating agents, complexing agents and rheology additives.

The face mixture can in particular contain up to 5 wt. % or up to 10 wt. % cement. Alternatively, the face mixture can in particular be free of cement. If the face mixture is free of cement, concrete elements can in particular be produced which have an advantageous carbon dioxide footprint.

The face mixture advantageously contains hardening regulators. In particular, setting retarders and/or setting accelerators may be considered as hardening regulators.

The core mixture may also contain one or more aggregates, such as gravel, grit, sand, pearlite, kieselguhr or vermiculite. Furthermore, the core mixture can contain cement and/or one or more aggregates, such as gravel, grit, sand, perlite, kieselguhr or vermiculite, and/or one or more additives selected from the group consisting of plasticizers, anti-foaming agents, water retention agents, dispersants, pigments, fibers, redispersible powders, wetting agents, impregnating agents, complexing agents and rheology additives.

In addition, the core concrete layer can also have other aggregates. The core concrete layer preferably contains 1 wt. % or more, preferably 5 wt. % or more, more preferably 15 wt. % or more, particularly preferably 17.5 wt. % or more, of opal, flint, chalcedony and/or graywacke. According to a preferred embodiment, the core concrete layer contains 5 wt. % to 30 wt. %, in particular 5 wt. % to 20 wt. % of opal, flint, chalcedony and/or graywacke. It has been found that by using these additives in these amounts, the concrete elements can be produced economically, but the alkali-silica reaction is still not very pronounced.

According to one embodiment, the core concrete layer has a free alkali content of 1500 g/m³ and more.

The core mixture can in particular contain up to 5 wt. % or up to 10 wt. % cement. Alternatively, the core mixture can in particular be free of cement. If the core mixture is free of cement, concrete elements can in particular be produced which have an advantageous carbon dioxide footprint.

The core mixture advantageously contains hardening regulators. In particular, setting retarders and/or setting accelerators may be considered as hardening regulators.

The properties of the face mixture and/or of the core mixture can be

20 controlled well with the aforementioned additives. In particular, the hardening behavior can also be controlled well with the aforementioned additives.

The face mixture preferably contains 0.1 wt. % to 2 wt. %, more preferably 0.4 wt. % to 1.5 wt. %, of additives, based on the total weight of the face mixture. The face mixture expediently contains 0.025 wt. % to 0.097 wt. % or 1.5 wt. % to 2 wt. % of setting retarders and/or setting accelerators.

The core mixture preferably contains 0.1 wt. % to 1 wt. %, more preferably 0.3 wt. % to 0.9 wt. %, of additives, based on the total weight of the core mixture. The core mixture expediently contains 0.0225 wt. % to 0.0975 wt. % or 1.0 wt. % to 1.9 wt. % of setting retarders and/or setting accelerators.

The concrete element preferably has a compaction class according to the DIN 1045-2 CO or C01 standard. The concrete element is preferably a concrete block, a concrete slab, a concrete wall element or a concrete step.

Furthermore, the concrete element preferably has a compressive strength according to DIN EN 12390-3, in particular DIN EN 12390-3:2019-10, measured after 28 days, of less than 110 N/mm², preferably less than 100 N/mm², more preferably less than 85 N/mm², particularly preferably less than 82.5 N/mm².

Furthermore, the core concrete layer of the concrete element preferably has an adhesive tensile strength, measured according to the DAfStb (German Committee for Reinforced Concrete) directive “Protection and repair of concrete components”, Part 4, Section 5.5.11, 2001, of 1.0 MPa or more, preferably of 1.3 MPa or more, more preferably of 1.5 MPa or more, particularly preferably of 2.0 MPa or more, 28 days after production.

The concrete element according to the invention is characterized by a good bond adhesive tensile strength. Preferably, the concrete element has a bond adhesive tensile strength, measured according to the DAfStb directive “Protection and repair of concrete components”, Part 4, Section 5.5.11, 2001, of 0.75 MPa or more, preferably of 1.0 MPa or more, more preferably of 1.15 MPa or more, still more preferably of 1.3 MPa, particularly preferably of 1.5 MPa or more, 28 days after production.

The adhesive tensile strengths can in particular change within the first three to four months after production of the concrete element, and in particular they can increase during this time.

The invention also provides a method for producing concrete elements according to the invention, comprising the following steps:
a. preparing a face composition containing as constituents
   i. granular face material,
   ii. optional pigment,
   iii. optional filler,
   iv. water,
   v. latent hydraulic face binder and/or pozzolanic face binder, and
   vi. alkaline face curing agent,
b. mixing of the face composition to obtain a face mixture,
c. preparing a core composition containing as constituents
   i. granular core material,
   ii. water,
   iii. latent hydraulic core binder and/or pozzolanic core binder, and
   iv. alkaline core curing agent,
d. mixing of the core composition to obtain a core mixture,
   e. filling the core mixture and the face mixture into at least one mold,
f. compacting the core mixture and the face mixture in the mold to obtain at least one green concrete element.

Preferably, the core mixture and the face mixture are compacted in at least one mold. The compaction can take place by means of stamping, pressing and/or vibration.

During stamping, the concrete is preferably compacted in the mold by vibration for a period of 1 to 20 seconds, preferably 2.5 to 4.5 seconds. During stamping, the concrete can be compacted in the mold at a pressure of 1.0 MPa or less.

During pressing, the concrete is preferably compacted in the mold at a pressure of 125 MPa or more, more preferably 125 MPa to 250 MPa. During pressing, the concrete is preferably compacted in the mold for a period of 5 to 20 seconds, more preferably 5 to 10 seconds, substantially without vibration. The method steps are preferably carried out in the order specified above.

According to one embodiment, in step e. the face mixture is first poured into the mold and then the core mixture is poured onto the face mixture in the mold and subsequently the face mixture is compacted in contact with the core mixture in the mold.

According to another embodiment, in step e. the core mixture is first poured into the mold and then the face mixture is poured onto the face mixture in the mold and subsequently the core mixture is compacted in contact with the face mixture in the mold.

According to an alternative embodiment, in step e. the core mixture is not poured into a mold, but is pressed into a strand and simultaneously or subsequently the face mixture is pressed into the strand and thereafter in step f. the core mixture is compacted in contact with the face mixture in the strand. The concrete elements are obtained from the strand by cutting to size and placing on mold panels.

Furthermore, the constituents of the face composition are advantageously metered in the order given. Expediently, the constituents of the core composition are metered in the order given. It has been found that when the constituents are added in the order given above, good processability of the face composition and/or the core composition is achieved. It has also proven to be expedient if the constituents of the face composition are already mixed during metering. The same applies to the core composition.

For the granular face material, the granular core material, the face filler, the core filler, the water, the latent hydraulic face binder and/or the pozzolanic face binder, the latent hydraulic core binder and/or the pozzolanic core binder, the alkaline face curing agent and the alkaline core curing agent, the statements made above for the concrete element according to the invention apply accordingly, in particular also with regard to the amounts of the constituents used.

Furthermore, the face composition and/or the core composition may also contain the additional constituents listed above, such as cement, aggregates, additives, setting retarders and/or setting accelerators. Aggregates, additives, setting retarders and/or setting accelerators are advantageously metered in with the water or the optional pigment, preferably with the water.

Using the method according to the invention, it is possible to design the surface of the concrete elements. According to one embodiment, a portion of a granular material containing (a) a litter component with an average grain diameter of 0.1 to 5 mm in an amount of 65 to 95 wt. %, preferably 75 to 85 wt. %, and (b) a binder in an amount of 5 to 35 wt. %, preferably 15 to 25 wt. %, based on the total composition of the granular material, is applied to the face mixture in the at least one mold prior to compaction.

By using the litter component and the binder in these concentration ranges, the granular material can be well anchored on the surface of the concrete element.

The average grain diameter is understood by those skilled in the art to refer to the diameter in which there are the same number of grains with a larger and a smaller diameter. The average grain diameter can be determined, for example, by sieving.

In order to produce especially aesthetically appealing concrete elements in accordance with this embodiment of the method according to the invention, it has proven advantageous that the face concrete layer has an optical property, such as color or degree of gloss, and that the granular material has an optical property which deviates therefrom. This makes it possible, for example, to create flamed, veined or speckled surfaces that look similar to the natural structure of natural stones.

According to this embodiment, the granular material is preferably applied to the mixture by means of an application device. The application device can have at least one trickling device, a centrifugal disc, a paddle wheel, a limb and/or a catapult, to which at least a portion of the granular material is fed. These devices can move over the mold or next to the mold, and they can also be fed different portions at different intervals. This way, the granular material can be applied evenly to the mixture. It has also been found that the method according to the invention can be carried out particularly economically in this way.

The application device advantageously has at least one metering container containing the granular material and a metering strip, with the metering container being guided over the mold at a uniform or non-uniform speed.

Vibrations or vibratory shocks, which are carried out uniformly and/or irregularly and/or intermittently, are preferably exerted on the metering strip.

Different finishing materials and/or different portions of finishing material can preferably be supplied to the metering strip along its extension.

Furthermore, it has also proven advantageous if the metering container is attached to the front edge of the metering carriage for the concrete, preferably the face concrete.

Possible configurations of an application device with at least one metering container with a metering strip are described for example in EP 2 910 354 A1. An example of an application device with at least one metering container with a metering strip is a filling carriage with at least one chamber. The granular material may be contained in this chamber. The filling carriage may also have two or more chambers separated by a partition. In that case, the mixture according to the invention is advantageously contained in a first chamber of the filling carriage. The granular material is preferably contained in a second chamber. Additional compartments may contain other granular materials with different properties, for example a different color. The filling carriage may be moved over a mold along a guide rail.

The chamber with the granular material may have an application element. The application element can be removed from the chamber. The chamber can have one or more application elements.

The application element preferably has a perforated metering plate with at least one, preferably several holes and a metering element. The holes can be arranged uniformly in the metering plate or in a pattern. The holes can have the same or different diameters. The metering plate can be flat or curved. The metering plate can also be cylindrical. The metering plate can in particular form the metering strip.

The metering element can be designed differently. The metering element can, for example, comprise a shaft, to which blades are attached, which can be rotated about the longitudinal axis of the shaft. The granular material is preferably located in the spaces formed by two blades of the shaft and the associated section of the metering plate. By rotating the shaft about its longitudinal axis, the blades push the granular material through the holes in the metering plate, thereby applying it to the mixture. Such a metering element is preferably used in conjunction with a curved metering plate.

The metering element can also be designed like a comb. In that case, the comb-like metering element preferably rests movably on a flat metering plate. The granular material is preferably located between the teeth of the comb on the metering plate. By moving the comb on the metering plate, the granular material is pressed through the holes of the metering plate and is thus applied to the mixture.

The metering element can also be a perforated plate. The perforated plate preferably rests on a flat metering plate. The granular material is preferably located in the holes of the perforated plate on the metering plate. By moving the perforated plate on the metering plate, the granular material is pressed through the holes of the metering plate and is thus applied to the mixture.

Finally, the metering element can also be a freely movable element, which is preferably arranged inside a cylindrical metering plate. The granular material is preferably also arranged inside the cylindrical metering plate. The freely movable element is, due to its weight, able to press the granular material through the holes of the metering plate. By moving, in particular rotating, the cylindrical metering plate, the granular material is pressed through the holes of the metering plate and thus applied to the mixture.

The application element advantageously also comprises further components, such as an actuator, with which the metering element can be moved. The actuator can be connected to an electric motor, which can preferably be controlled by electronic control means. The application element can also have an actuator rod, a cam follower, which is in engagement with a cam, and/or a gear.

According to a preferred embodiment of the method according to the invention, the application device comprises at least one pipe socket, to which one or more portions of a granular material are fed and through which these are scattered, thrown, shot and/or dropped onto the face concrete layer. A particularly good distribution across the mold occurs if the end of the pipe socket is designed in the manner of a nozzle.

Practical tests have shown the method according to the invention results in a good distribution, if the ejection takes place by means of a prestressed, spring-loaded piston, whose lock is suddenly released so that the material can be thrown.

The application device can preferably be moved above the mold and/or next to the mold. It can have or achieve different speeds of movement, with jerky movements being advantageous as well. Depending on the size of the mold and the color of the granular material in the application device, several and also different devices can be used for one mold, so that the application is evened out or a special characteristic application look is achieved for the granular material.

Baffle plates are preferably used in the application devices, since such disc wheels or limbs and also pipe sockets can have a wider scattering.

Several portions of the granular material can, one after the other, be ejected by the application devices, which may be different granular materials, as described above.

Preferably, the binder contained in the granulated material is an inorganic binder, such as cement, hydraulic lime, gypsum, slag, blast furnace slag, preferably slag sand, in particular ground slag sand, electrothermal phosphorus slag, steel slag, amorphous silicon dioxide, precipitated silicon dioxide, pyrogenic silicon dioxide, microsilica, glass powder, fly ash, such as lignite fly ash or hard coal fly ash, metakaolin, natural pozzolans, such as tuff, trass or volcanic ash, natural and synthetic zeolites or water glass, or the binder contained in the granular material is an organic binder, such as plastic dispersions, acrylate resins, alkyd resins, epoxy resins, polyurethanes, sol-gel resins or silicone resin emulsions. Such binders are particularly easy to handle in connection with concrete elements. In addition, they make no additional demands on the method. Furthermore, such binders enable the granular material to be well anchored on the concrete element.

Depending on the desired visual look of the concrete element, litter components with different mean grain diameters can be used. A litter component with an average grain diameter of 0.1 to 1.8 mm can be used as the litter component. Alternatively, a litter component with an average grain diameter of 1.2 to 5 mm can be used.

A litter component with an average grain diameter of 0.1 to 1.2 mm is preferably used.

The granular material can also contain small aggregates so that different types of materials with different colors, including granules of semi-precious stones, precious stones, mica, metal chips, plastic particles or glass particles can be incorporated into the surface or face concrete layer. The granular material can also be any rock mixture.

It has proven particularly practical for the method according to the invention if the litter component is or contains a rock mixture. This makes it possible to produce concrete elements that come very close to a natural stone look.

In the method according to the invention, the litter component preferably contains at least material selected from the group of semi-precious stones, precious stones, mica, metal chips, glass and plastic particles. The use of these materials allows for a very economical method.

In the method according to the invention, the granular material can in particular have a graded grain composition of no more than 2 mm grain diameter.

The surfaces and/or edges of the at least one green concrete element can be processed with brushes in the method according to the invention and thereby structured and/or roughened and/or smoothed and/or protrusions reduced at the edges. This can further enhance a decorative visual look.

Before, but preferably after the compacting step, an organic or inorganic agent, which is preferably colorless, can be applied to the surfaces of the concrete elements before or after the hardening. This is done to waterproof, seal or coat the concrete elements. In particular, a sealing and/or waterproofing agent can be applied to the surface of the at least one green concrete element. Such a procedure adds a further protective layer to the concrete elements, which increases the durability and service life of the concrete elements even more. This layer can also act as a stain protector and additionally prevent lime efflorescence.

The green concrete element is preferably cured in the method according to the invention in order to obtain a concrete element. After having cured, the concrete element is preferably processed by grinding, blasting, brushing and/or structuring the concrete element.

The present invention also relates to the use of latent hydraulic binder and/or pozzolanic binder, in particular as binder, together with alkaline curing agent for producing a core concrete layer in a concrete element comprising a core concrete layer and a face concrete layer connected thereto.

Preferably, the statements made above regarding the concrete element according to the invention apply accordingly to the concrete element.

Preferably, the statements made above regarding the latent hydraulic core binder apply accordingly to the latent hydraulic binder. This also applies to the amounts specified above.

Preferably, the statements made above regarding the pozzolanic core binder apply accordingly to the pozzolanic binder. This also applies to the amounts specified above.

Preferably, the statements made above regarding the alkaline face curing agent and/or core curing agent apply accordingly to the alkaline curing agent.

According to one embodiment, the core concrete layer contains granular core material, for which the above statements regarding the granular core material apply accordingly. This also applies to the amounts specified above.

According to a further embodiment, the face concrete layer contains granular face material, for which the above statements regarding the granular face material applies accordingly. This also applies to the amounts specified above.

According to a further embodiment, the face concrete layer contains face filler, for which the above statements regarding the face filler apply accordingly. This also applies to the amounts specified above.

According to a further embodiment, the core concrete layer contains core filler, for which the above statements regarding the core filler apply accordingly. This also applies to the amounts specified above.

According to a further embodiment, the core concrete layer contains 1 wt. % or more, preferably 5 wt. % or more, more preferably 15 wt. % or more, particularly preferably 17.5 wt. % or more, of opal, flint, chalcedony and/or graywacke.

According to a further embodiment, the core concrete layer contains 5 wt. % to 30 wt. %, in particular 5 wt. % to 20 wt. % of opal, flint, chalcedony and/or graywacke.

The concrete element of the use according to the invention is preferably a concrete element according to the invention.

For further explanation, non-limiting examples are listed below.

### EXAMPLES

### Materials

### For Geopolymer Layers

Face binder mixture: containing mainly latent hydraulic binders and pozzolanic binders.

Core binder mixture: containing mainly latent hydraulic binders and pozzolanic binders.

Granular face material: aggregate with a through fraction of 72.5 wt. % at a screen hole width of 2 mm and a through fraction of 7.5 wt. % at a screen hole width of 0.25 mm.

Granular core material: aggregate with a through fraction of 98.8 wt. % at a screen hole width of 8 mm and a through fraction of 18.0 wt. % at a screen hole width of 0.5 mm.

Face filler: rock powder with a through fraction of 97 wt. % at a screen hole width of 0.025 mm and a through fraction of 63 wt. % at a screen hole width of 0.015 mm.

Alkaline face curing agent: 75% silica.

Alkaline core curing agent: 40% aqueous solution of an inorganic base.

Pigment: metal oxide pigment.

Additive for the face mixture: setting retarder/setting accelerator.

Optionally cement: Portland cement CEM I 42.5R

Granular material: containing 80 wt. % of small aggregates with an average grain diameter of 0.7 mm and 20 wt. % of inorganic binder.

### For Conventional Layers

Core binder mixture: Portland cement CEM I 52.5N

Granular core material: aggregate with a through fraction of 98.8 wt. % at a screen hole width of 8 mm and a through fraction of 18.0 wt. % at a screen hole width of 0.5 mm.

Core filler: rock powder with a through fraction of 97 wt. % at a screen hole width of 0.025 mm and a through fraction of 63 wt. % at a screen hole width of 0.015 mm.

### Methods

The adhesive tensile strength is determined in accordance with the DAfStb guideline “Protection and repair of concrete components,” Part 4, section 5.5.11, 2001. In deviation from this, a drilling depth of 30 mm and 5 mm is chosen. The adhesive tensile strength of the core layer was determined by testing the underside. The face or bond adhesive tensile strength is obtained by assessing the tear depth (tear location).

### Example 1

76.0 wt. % granular core material, 5.3 wt. % water, 17.0 wt. % core binder mixture and 1.7 wt. % alkaline core curing agent were successively poured into a mixing container to obtain a core composition, with the above figures being based on the total weight of the core composition. The core composition was then mixed in the mixing container to obtain a core mixture. The core mixture thus obtained was poured as a core concrete layer into molds of a mold board.

66.6 wt. % of granular face material, 1.1 wt. % of pigment, 6.4 wt. % of water, 21.6 wt. % of a face binder mixture, 4.26 wt. % of alkaline face curing agent and 0.04 wt. % of an additive were successively added to a further mixing container to obtain a face composition, with the above information relating to the total weight of the face composition. The face composition was then mixed in the mixing container to obtain a face mixture. The face mixture thus obtained was poured into the molds of the above mold board as a face concrete layer. The face concrete layer had a basic color. The mixtures were then compacted in the mold by stamping, whereby a green concrete element was obtained. Based on what was observed when the mold was removed, the green concrete element did not tear apart. After demolding and curing, the concrete element had a measured adhesive tensile strength of at least 0.77 MPa (test age 7 d) and at least 1.15 MPa (test age 28 d). The tear was carried out in the face. The bond adhesive tensile strength is thus at least the measured 0.77 MPa (test age 7 d) and at least 1.15 MPa (test age 28 d). Furthermore, the concrete element had a compressive strength according to DIN EN 12390-3:2019-10 of 56.9 N/mm² (test age 7 d) and 60.8 N/mm² (test age 28 d).

In addition, the concrete element had an adhesive tensile strength in the core layer of 1.89 MPa (test age 10 d). After having cured, the concrete elements that were obtained were visually attractive. The concrete elements showed no discernible fading or any other deterioration in their decorative properties over a period of 6 months. Furthermore, over a period of 6 months, there were no signs of chemical attacks on the concrete elements that could result from an alkali-silica reaction.

### Example 2 (Comparative Example)

In example 2, a conventional, i.e., cement-based, core was produced as the core. For this purpose, 79.6 wt. % granular core material, 11.0 wt. % cement, 5.2 wt. % water and 4.2 wt. % core filler were poured into a mixing container and mixed. The core mixture thus obtained was poured as a core concrete layer into molds of a mold board.

The face mixture from example 1 was then poured onto the core mixture in the molds of the mold board. The face concrete layer had a basic color. The mixtures were then compacted in the mold by stamping, whereby a green concrete element was obtained. Based on what was observed when the mold was removed, the green concrete element did not tear apart. After demolding and curing, the concrete element had a measured adhesive tensile strength of at least 0.41 MPa (test age 7 d) and at least 0.75 MPa (test age 28 d). The tear was made in the composite layer. The measured adhesive tensile strength is thus the bond adhesive tensile strength. Furthermore, the concrete element had a compressive strength of 61.1 N/mm² in accordance with DIN EN 12390-3:2019-10.

### Example 3 (Comparative Example)

First, a conventional core mixture was produced as in example 2 and poured into the molds of a mold board.

A face mixture was then produced as in example 1, with the difference that only 15.3 wt. % face binder was used and an additional 6.3 wt. % cement was added. The face composition was then mixed in the mixing container to obtain a face mixture. The face mixture thus obtained was poured into the molds of the above mold board as a face concrete layer. The face concrete layer had a basic color. The mixtures were then compacted in the mold by stamping, whereby a green concrete element was obtained. Based on what was observed when the mold was removed, the green concrete element did not tear apart. After demolding and curing, the concrete element had a measured adhesive tensile strength of at least 0.26 MPa (test age 7 d) and at least 0.28 MPa (test age 28 d). The tear was made in the composite layer. The measured adhesive tensile strength is thus the bond adhesive tensile strength.

### Example 4

Example 4 is identical to example 1 with the difference that 74.8 wt. % granular core material, 5.5 wt. % water, 17.9 wt. % core binder mixture and 1.8 wt. % alkaline core curing agent for the core composition were poured in. Before stamping, any desired portions of a granular material were scattered, thrown, shot and/or dropped onto the face concrete layer, which was poured in and was identical to example 1, with the aid of a pipe socket designed like a nozzle. The application device was able to move across the mold board, so that all face concrete layers in the molds could be reached as desired. A funnel, into which the granular material was poured, was placed above the pipe socket. Any portion of the granular material could be directed onto the pipe socket by means of an opening and closing device that was arranged on the lower hopper opening. In principle, several hoppers containing different granulated materials can be arranged above the centrifugal disc in order to scatter, throw, shoot and/or drop different granulated materials in different dosages onto the surfaces of the face concrete layers. The pipe socket could be moved at different movement speeds, including jerky movements. The height position relative to the mold board could also be adjusted and varied as desired, even during the application of the granulated material. Based on what was observed when the mold was removed, the green concrete element did not tear apart. After demolding and curing, the concrete element had a measured adhesive tensile strength of at least 0.83 MPa (test age 7 d) and at least 1.17 MPa (test age 28 d). The tear was carried out in the face. The bond adhesive tensile strength is thus at least the measured 0.77 MPa (test age 7 d) and 1.15 MPa (test age 28 d). Furthermore, the concrete element had a compressive strength according to DIN EN 12390-3:2019-10 of 67.0 N/mm² (test age 7 d) and 74.4 N/mm² (test age 28 d). In addition, the concrete element had an adhesive tensile strength in the core layer of 2.18 MPa (test age 10 d).

As can be seen from the examples, a combination of geopolymer-based core and geopolymer-based face results in very good bond adhesive tensile strength (examples 1 and 4). At the same time, these concrete elements based entirely on geopolymers showed very good resistance to chemical corrosion.

The combinations of a conventional core with a geopolymer-based face layer (example 2) and with a hybrid face layer of geopolymers and cement (example 3) showed poorer bond adhesive tensile strengths.

1. Concrete element comprising a core concrete layer and a face concrete layer, wherein the concrete element is obtained by compressing and curing a core concrete layer mixture in contact with a face concrete layer mixture,
wherein the core concrete layer mixture contains a latent hydraulic core binder and/or a pozzolanic core binder, water, a granular core material and an alkaline core curing agent,
wherein the face concrete layer mixture contains a latent hydraulic face binder and/or a pozzolanic face binder, water, a granular face material and an alkaline face curing agent,
wherein the granular face material has, at a screen hole width of 2 mm, a through fraction from 35.5 wt. % to 99.5 wt. %, and, at a screen hole width of 0.25 mm, a through fraction from 2.5 wt. % to 33.5 wt. %, in each case based on the total weight of the granular face material, and
wherein the concrete element has a compressive strength in accordance with DIN EN 12390-3, in particular DIN EN 12390-3:2019-10, measured after 28 days, of less than 120 N/mm².

2. Concrete element according to claim 1, characterized in that the granular face material has, at a screen hole width of 2 mm, a through fraction of 42.5 wt. % to 99.5 wt. %, more preferably from 56.5 wt. % to 98.5 wt. %, particularly preferably from 72.5 wt. % to 97.5 wt. %, and, at a screen hole width of 0.25 mm, a through fraction of 2.5 wt. % to 27.5 wt. %, more preferably from 2.5 wt. % to 22.5 wt. %, even more preferably from 2.5 wt. % to 21.5 wt. %, particularly preferably from 2.5 wt. % to 8 wt. % or from 11.5 wt. % to 21.5 wt. %, and, at a screen hole width of 0.125 mm, a through fraction of 0.1 wt. % to 12.5 wt. %, more preferably from 0.3 wt. % to 10.0 wt. %, even more preferably from 0.3 wt. % to 7.5 wt. %, particularly preferably from 0.3 wt. % to 5.0 wt. %, based on the total weight of the granular face material,
and/or in that the granular core material has, at a screen hole width of 8 mm, a through fraction from 42.5 wt. % to 99.5 wt. %, preferably from 56.5 wt. % to 98.5 wt. %, more preferably from 72.5 wt. % to 97.5 wt. %, and, at a screen hole width of 0.5 mm, a through fraction from 7.5 wt. % to 39.5 wt. %, preferably from 13.5 wt. % to 37.5 wt. %, particularly preferably from 25.5 wt. % to 37 wt. % or from 14.5% to 24.5 wt. % based on the total weight of the granular core material.

3. Concrete element according to one of claim 1 or 2, characterized in that the granular face material has a grain size number from 1.59 to 3.62, preferably from 1.61 to 3.17, particularly preferably from 1.61 to 2.55
and/or in that the granular core material has a grain size number from 1.97 to 4.61, preferably from 2.27 to 3.82.

4. Concrete element according to one of the preceding claims, characterized in that the face mixture contains 55 wt. % to 80 wt. %, preferably 60 wt. % to 75 wt. %, more preferably 60 wt. % to 72 wt. % %, particularly preferably 60 wt. % to 65 wt. %, in particular 60 to 64 wt. %, or 67 wt. % to 72 wt. %, of the granular face material, based on the total weight of the face mixture,
and/or in that the core mixture contains 60 wt. % to 95 wt. %, preferably 65 wt. % to 92.5 wt. %, more preferably 70 wt. % to 90 wt. %, particularly preferably 74 wt. % to 79 wt. %, of the granular core material, based on the total weight of the core mixture.

5. Concrete element according to one of the preceding claims, characterized in that the face mixture contains 1 wt. % to 30 wt. %, preferably 1 wt. % to 20 wt. %, more preferably 5 wt. % to 18 wt. %, still more preferably 5 wt. % to 15 wt. %, even more preferably 5 wt. % to 10 wt. %, particularly preferably 6 wt. % to 8 wt. %, of a face filler, based on the total weight of the face mixture,
and/or in that the core mixture contains 1 wt. % to 40 wt. %, preferably 10 wt. % to 30 wt. %, more preferably 12.5 wt. % to 30 wt. %, particularly preferably 15 wt. % to 27.5 wt. % of a core filler, based on the total weight of the core mixture.

6. Concrete element according to claim 5, characterized in that the face filler has, at a screen hole width of 0.025 mm, a through fraction from 63 wt. % to 99 wt. %, preferably from 68 wt. % to 99 wt. %, more preferably from 90 wt. % to 99 wt. % and particularly preferably from 95 wt. % to 99 wt. %, and, at a screen hole width of 0.015 mm, a through fraction from 38 wt. % to 73 wt. %, preferably from 58 wt. % to 67 wt. %, particularly preferably from 61 wt. % to 66 wt. %, based on the total weight of the face filler,
and/or in that the core filler has, at a screen hole width of 0.025 mm, a through fraction from 63 wt. % to 99 wt. %, preferably from 68 wt. % to 99 wt. %, more preferably from 90 wt. % to 99 wt. %, particularly preferably from 95 wt. % to 99 wt. %, and, at a screen hole width of 0.015 mm, a through fraction from 38 wt. % to 73 wt. %, preferably from 58 wt. % to 67 wt. %, particularly preferably from 61 wt. % to 66 wt. %, based on the total weight of the core filler.

7. Concrete element according to one of claim 5 or 6, characterized in that the face filler is selected from the group consisting of rock powder, preferably classified rock powder, limestone powder, preferably classified limestone powder, and mixtures thereof,
and/or in that the core filler is selected from the group consisting of rock powder, preferably classified rock powder, limestone powder, preferably classified limestone powder, and mixtures thereof.

8. Concrete element according to one of the preceding claims, characterized in that the face mixture contains 15 wt. % to 40 wt. %, preferably 20 wt. % to 30 wt. %, further preferably 20 wt. % to 24 wt. % or 26 wt. % to 29 wt. %, more preferably 22 wt. % to 24 wt. %, of latent hydraulic face binder and/or pozzolanic face binder, based on the total weight of the face mixture,
and/or in that the core mixture contains 10 wt. % to 50 wt. %, preferably 10 wt. % to 40 wt. %, of latent hydraulic core binder and/or pozzolanic core binder, based on the total weight of the core mixture.

9. Concrete element according to one of the preceding claims, characterized in that the latent hydraulic face binder is selected from the group consisting of slag, blast furnace slag, preferably slag sand, in particular ground slag sand, electrothermal phosphorus slag, steel slag, and mixtures thereof, and/or in that the molar ratio of (CaO+MgO):SiO₂ in the latent hydraulic face binder ranges from 0.8 to 2.5, preferably from 1.0 to 2.0,
and/or in that the latent hydraulic core binder is selected from the group consisting of slag, blast furnace slag, preferably slag sand, in particular ground slag sand, electrothermal phosphorus slag, steel slag, and mixtures thereof, and/or in that the molar ratio of (CaO+MgO):SiO₂ in the latent hydraulic core binder ranges from 0.8 to 2.5, preferably from 1.0 to 2.0.

10. Concrete element according to one of the preceding claims, characterized in that the pozzolanic face binder is preferably selected from the group consisting of amorphous silicon dioxide, precipitated silicon dioxide, pyrogenic silicon dioxide, microsilica, glass powder, fly ash, such as lignite fly ash or hard coal fly ash, metakaolin, natural pozzolans, such as tuff, trass or volcanic ash, natural and synthetic zeolites and mixtures thereof,
and/or in that the pozzolanic core binder is selected from the group consisting of amorphous silicon dioxide, precipitated silicon dioxide, pyrogenic silicon dioxide, microsilica, glass powder, fly ash, such as lignite fly ash or hard coal fly ash, metakaolin, natural puzzolans, such as tuff, trass or volcanic ash, natural and synthetic zeolites and mixtures thereof.

11. Concrete element according to one of the preceding claims, characterized in that the alkaline face curing agent is selected from the group consisting of alkali metal oxides, alkali metal hydroxides, alkali metal carbonates, alkali metal silicates, alkali metal aluminates and mixtures thereof, preferably consisting of alkali metal hydroxides, alkali metal silicates and mixtures thereof,
and/or in that the alkaline core curing agent comprises an organic and/or an inorganic base.

12. Concrete element according to one of the preceding claims, characterized in that the face mixture contains 1 wt. % to 15 wt. %, preferably 1 wt. % to 10 wt. %, more preferably 3 wt. % to 5 wt. %, even more preferably 3.15 wt. % to 4.85 wt. %, even more preferably 3.25 wt. % to 3.65 wt. % or 4.0 wt. % to 4.75 wt. %, particularly preferably 4.25 wt. % to 4.75 wt. %, very particularly preferably 4.25 wt. % to 4.45 wt. %, of the alkaline face curing agent, based on the total weight of the face mixture,
and/or in that the core mixture contains 0.1 wt. % to 15 wt. %, preferably 0.5 wt. % to 10 wt. %, of the alkaline core curing agent, based on the total weight of the core mixture.

13. Concrete element according to one of the preceding claims, characterized in that the face mixture contains 1 wt. % to 20 wt. %, preferably 3 wt. % to 15 wt. %, more preferably 3 wt. % to 7 wt. %, even more preferably 3.5 wt. % to 6.5 wt. %, even more preferably 4.0 wt. % to 6.2 wt. %, particularly preferably 4.2 wt. % to 4.9 wt. % or 5.2 wt. % to 6.2 wt. %, very particularly preferably 4.2 wt. % to 4.8 wt. %, of water, based on the total weight of the face mixture,
and/or in that the core mixture contains 1 wt. % to 20 wt. %, preferably 3 wt. % to 15 wt. %, more preferably 3 wt. % to 10 wt. %, of water, based on the total weight of the core mixture.

14. Concrete element according to one of the preceding claims, characterized in that the face mixture has hardening regulators, in particular setting retarders and/or setting accelerators,
and/or in that the core mixture has hardening regulators, in particular setting retarders and/or setting accelerators.

15. Concrete element according to one of the preceding claims, characterized in that the face mixture contains cement, in particular up to 5 wt. % or up to 10 wt. % cement, and/or one or more aggregates, such as gravel, grit, sand, perlite, kieselguhr or vermiculite, and/or one or more additives selected from the group consisting of plasticizers, anti-foaming agents, water retention agents, dispersants, pigments, fibers, redispersible powders, wetting agents, impregnating agents, complexing agents and rheology additives,
and/or that the core mixture contains cement, in particular up to 5 wt. % or up to 10 wt. % cement, and/or one or more aggregates, such as gravel, grit, sand, perlite, kieselguhr or vermiculite, and/or one or more additives selected from the group consisting of plasticizers, anti-foaming agents, water retention agents, dispersants, pigments, fibers, redispersible powders, wetting agents, impregnating agents, complexing agents and rheology additives.

16. Concrete element according to one of the preceding claims, characterized in that the concrete element has a compressive strength according to DIN EN 12390-3, in particular DIN EN 12390-3:2019-10, measured after 28 days, of less than 110 N/mm², preferably less than 100 N/mm², more preferably less than 85 N/mm², particularly preferably less than 82.5 N/mm².

17. Concrete element according to one of the preceding claims, characterized in that the core concrete layer of the concrete element has an adhesive tensile strength, measured according to the DAfStb (German Committee for Reinforced Concrete) directive “Protection and repair of concrete components”, Part 4, Section 5.5.11, 2001, of 1.0 MPa or more, preferably of 1.3 MPa or more, more preferably of 1.5 MPa or more, particularly preferably of 2.0 MPa or more, 28 days after production.

18. Concrete element according to one of the preceding claims, characterized in that the concrete element has a bond adhesive tensile strength, measured according to the DAfStb (German Committee for Reinforced Concrete) directive “Protection and repair of concrete components”, Part 4, Section 5.5.11, 2001, of 0.75 MPa or more, preferably of 1.0 MPa or more, more preferably of 1.15 MPa or more, even more preferably of 1.3 MPa or more, particularly preferably of 1.5 MPa or more, 28 days after production.

19. Concrete element according to one of the preceding claims, characterized in that the core concrete layer contains 1 wt. % or more, preferably 5 wt. % or more, more preferably 15 wt. % or more, particularly preferably 17.5 wt. % or more, of opal, flint, chalcedony and/or graywacke.

20. Concrete element according to one of the preceding claims, characterized in that the concrete element is a concrete block, a concrete slab, a concrete wall element or a concrete step.

21. Method for producing a concrete element according to one of claims 1 to 20, comprising the following steps:
a. preparing a face composition containing as constituents
i. granular face material,
ii. optional pigment,
iii. optional filler,
iv. water,
v. latent hydraulic face binder and/or pozzolanic face binder, and
vi. alkaline face curing agent,
b. mixing of the face composition to obtain a face mixture,
c. preparing a core composition containing as constituents
i. granular core material,
ii. water,
iii. latent hydraulic core binder and/or pozzolanic core binder, and
iv. alkaline core curing agent,
d. mixing of the core composition to obtain a core mixture,
e. filling the core mixture and the face mixture into at least one mold,
f. compacting the core mixture and the face mixture in the mold to obtain at least one green concrete element.

22. Method according to claim 21, characterized in that the constituents of the face composition are metered in the order given.

23. Method according to one of claim 21 or 22, characterized in that the core mixture is filled into the at least one mold before the face mixture.

24. Method according to claim 23, characterized in that the core mixture is compacted before the face mixture is added.

25. Method according to one of claims 21 to 24, characterized in that a portion of a granular material containing (a) a litter component with an average grain diameter of 0.1 to 5 mm in an amount of 65 to 95 wt. %, and (b) a binder in an amount of 5 to 35 wt. %, based on the total composition of the granular material, is applied to the face mixture in the at least one mold prior to compaction.

26. Method according to claim 25, characterized in that the binder contained in the granular material is preferably an inorganic binder, such as cement, hydraulic lime, gypsum or sodium silicate or that the binder contained in the granular material is an organic binder, such as plastic dispersions, acrylate resins, alkyd resins, epoxy resins, polyurethanes, sol-gel resins or silicone resin emulsions, and/or that a litter component with an average grain diameter of 0.1 to 1.8 mm or from 1.2 to 5 mm is used as the litter component, and/or that the litter component is or contains a rock mixture, or that the litter component contains at least material selected from the group of semi-precious stones, precious stones, mica, metal chips, glass and plastic particles.

27. Method according to claim 25 or 26, characterized in that the granular material is applied by scattering or throwing, and/or in that the granular material is applied to the face mixture by means of an application device, wherein the application device has at least one pipe socket to which one or more portions of a granular material are fed and through which these are scattered, thrown, shot and/or dropped onto the concrete layer.

28. Method according to one of claims 21 to 27, characterized in that the surfaces and/or edges of the at least one green concrete element are processed with brushes and thus structured and/or roughened and/or smoothed and/or protrusions reduced at the edges.

29. Method according to one of claims 21 to 28, characterized in that a sealing and/or waterproofing agent is applied to the surface of the at least one green concrete element.

30. Method according to one of claims 21 to 29, characterized in that the green concrete element is cured to obtain a concrete element, wherein the concrete element is preferably processed after it has cured by grinding, blasting, brushing and/or structuring the concrete element.

31. Use of latent hydraulic binder and/or pozzolanic binder, in particular as binder, together with alkaline curing agent for producing a core concrete layer in a concrete element comprising a core concrete layer and a face concrete layer connected thereto.

32. Use according to claim 31, characterized in that the latent hydraulic binder is as defined for the core binder in claim 9, and/or in that the pozzolanic binder is as defined for the pozzolanic core binder in claim 10, and/or in that the core concrete layer contains granular core material as defined in claims 1 to 4, and/or in that the face concrete layer contains granular face material as defined in claims 1 to 4, and/or in that the core concrete layer contains core filler as defined in claims 6 and 7, and/or in that the face concrete layer contains face filler as defined in claims 6 and 7, and/or in that the alkaline curing agent is as defined in claim 11, and/or in that the concrete element is defined by at least one feature of claim 16, 18 or 20, and/or in that the core concrete layer contains 1 wt. % or more, preferably 5 wt. % or more, more preferably 15 wt. % or more, particularly preferably 17.5 wt. % or more, of opal, flint, chalcedony and/or graywacke.
